(19) United States
(12) Patent Application Publication
(10) Pub. No.: US 2014/0347806 A1
(43) Pub. Date: Nov. 27, 2014

(54) IMAGE DISPLAY DEVICE

(71) Applicant: Masateru Totani, Yao-shi (JP)

(72) Inventor: Masateru Totani, Yao-shi (JP)

(21) Appl. No.: 14/277,084

(22) Filed: May 14, 2014

(30) Foreign Application Priority Data
May 21, 2013 (JP) 2013-002808
Jun. 7, 2013 (JP) 2013-120526

(51) Int. Cl. G06F 1/16

(52) U.S. Cl. CPC G06F 1/1681; G06F 1/1647
USPC 361/679.27

(57) ABSTRACT

An object of the present invention is to provide a folding image display device that can used in small electronic equipment such as portable information terminals, and in particular, an image display device capable of achieving various screen arrangements and usages of an inflexible image display device section. There is provided an image display device including a substantially plate-like first housing (display unit) having a first display section, and a substantially plate-like second housing (display unit) having a second display section, the first housing and the second housing are connected to each other via a connecting portion so as to be rotatable and/or slidable with respect to each other, the first housing and the second housing are adjustable at any relative angle or position, and the first display section and the second display section can be substantially flush with each other.

### TECHNICAL FIELD

The present invention relates to an image display device, and in particular, a folding and/or sliding image display device suitably used in small electronic equipment such as portable information terminals.

### BACKGROUND ART

The miniaturization of personal information terminals including notebook personal computers, PDAs, and mobile phones has been desired to provide increased portability. For example, while A4-sized notebook personal computers has been conventionally predominant, A6-sized mini personal computer has appeared in recent years. Unlike the personal computers, PDAs do not necessarily includes a keyboard and therefore, even smaller PDAs have been commercialized.

In such personal information terminals, a liquid crystal display has been generally used as a display for displaying image information processing results, and a smaller liquid crystal display is adopted as the terminal becomes smaller.

However, the conventional liquid crystal display thus miniaturized cannot often display much information at a time. Although more information can be displayed by increasing the resolution of the display, low visibility due to the small screen cannot be fully improved.

To address this problem, for example, Patent literature 1 (Japanese Unexamined Patent Publication No. 2006-174506) proposes a communication terminal including a substantially rectangular flexible display having a foldable visible screen; a substantially plate-like housing group in which two or more substantially plate-like housings are connected to each other side by side when viewed from the user; and a substantially plate-like communication terminal housing having a wireless communication unit, a voice input unit, and a voice output unit, wherein the substantially plate-like communication terminal housing is connected to the adjacent substantially plate-like housing so as to be foldable in the direction of the back surface of the substantially plate-like housing.

The communication terminal described in Patent literature 1 enables upsizing of the screen. In addition, for example, when the communication terminal is placed on a table, the user can view the screen with both hands free rather than supporting the terminal with the hands.

Patent literature 2 (Japanese Unexamined Patent Publication No. 10-207389) proposes an image display device including a plate-like flexible image display device section; and a storage casing that has an expansion/contraction mechanism, holds a display screen of the flexible image display device section to be viewable to the user during expansion of the casing, and deforms and stores the flexible image display device section during contraction of the casing.

In the image display device described in Patent literature 2, since the display screen of the flexible image display device section is kept viewable during the expansion of the storage casing, much more information can be clearly displayed even in the miniaturized electronic equipment.

### CITATION LIST

### Patent Literature

[Patent literature 1] Japanese Unexamined Patent Publication No. 2006-174506

[Patent literature 2] Japanese Unexamined Patent Publication No. Hei 10-207389

### SUMMARY OF THE INVENTION

### Technical Problem

The communication terminal proposed in Patent literature 1 mainly acts to fold the flexible display, and is not configured to interlock a plurality of general-purpose liquid crystal displays to achieve various arrangements of display screens.

The image display device proposed in Patent literature 2 is directed to use the flexibility of the image display device section to make the image display device section more compact for storage and thus, requires the use of a flexible display.

An object of the present invention is to provide a folding image display device that can be used in small electronic equipment such as portable information terminals, and in particular, an image display device capable of achieving various screen arrangements and usages of an inflexible image display device section.

### Solution to Problems

To attain the object, the present invention provides an image display device including:

a substantially plate-like first housing (display unit) having a first display section; and

a substantially plate-like second housing (display unit) having a second display section, wherein

the first housing and the second housing are connected to each other via a connecting portion so as to be rotatable and/or slidable with respect to each other,

the first housing and the second housing are adjustable at any relative angle or position, and

the first display section and the second display section can be substantially flush with each other.

An image display device according to the present invention may be an image display device including:

a substantially plate-like first housing having a first display section; and

a substantially plate-like second housing having a second display section; and

a substantially plate-like third housing having a third display section, and

the first housing and the second housing are connected to each other via a first connecting portion so as to be rotatable and/or slidable with respect to each other,

the second housing and the third housing are connected to each other via a second connecting portion so as to be rotatable and/or slidable with respect to each other,

the first housing, the second housing, and the third housing are adjustable at any relative angle or position, and

the first display section, the second display section, and the third display section can be substantially flush with each other.

In the image display device with such configuration according to the present invention, preferably, various types of information may be displayed on any of the first display section and the second display section (in some cases, and the third display section). It is possible that the image display device according to the present invention can be configured such that various types of information may be displayed on the first section and the second display section, respectively (for example, stock prices chart and exchange rate chart, respectively), and the third display section be used as a mobile phone.

In the image display device with such configuration according to the present invention, preferably, various types of information may be displayed on one integrated display means constituted of the first display section and the second display section (in some cases, and the third display section).

### Advantageous Effect of Invention

According to the present invention, by connecting the housings each having the display section to each other so as to be rotatable and slidable with respect to each other, the relative angle or position of the housings can be freely adjusted. Thus, the plurality of display sections can be integrated into one large screen, and only any of the display sections can display various types of information and be held at any suitable angle such that the user can easily view the display section. In addition, overlapping the housings enables compact storage.

### BRIEF DESCRIPTION OF THE DRAWINGS

FIG. 1 is a front view of an image display device in accordance with an embodiment of the present invention in the exploded state into a substantially flat plane;

FIG. 2 is a plan view of the image display device in accordance with the embodiment of the present invention in the fully folded state;

FIG. 3 is a plan view of the image display device in accordance with the embodiment of the present invention in the folded states at some angles;

FIG. 4 is a plan view of the image display device in accordance with the embodiment of the present invention in the folded states at some angles;

FIG. 5 is a plan view of an image display device in accordance with another embodiment of the present invention in the slid state;

FIG. 6 is a plan view of an image display device in accordance with still another embodiment of the present invention in the slid state;

FIG. 7 is a plan view of an image display device in accordance with another embodiment of the present invention;

FIG. 8 is a plan view of an image display device in accordance with still another embodiment of the present invention;

FIG. 9 is a plan view of an image display device in accordance with another embodiment of the present invention;

FIG. 10 is a plan view of an image display device in accordance with another embodiment of the present invention;

FIG. 11 is a front view of an image display device in accordance with still another embodiment of the present invention;

FIG. 12 is a front view of an image display device in accordance with still another embodiment of the present invention;

FIG. 13 is a front view of an image display device in accordance with still another embodiment of the present invention; and

FIG. 14 is a plan view of an image display device in accordance with still another embodiment of the present invention in the folded state at some angles.

### DESCRIPTION OF EMBODIMENT

While an image display device in accordance with typical embodiments of the present invention will be described below, as a matter of course, the image display device of the present invention is not limited to the depicted ones. In following description, the same or equivalent parts are given the same reference numerals and overlapping description thereof may be omitted. Figures intend to conceptually illustrate the present invention and for easier comprehension, size, ratio, or the number of items may be exaggerated or simplified as needed.

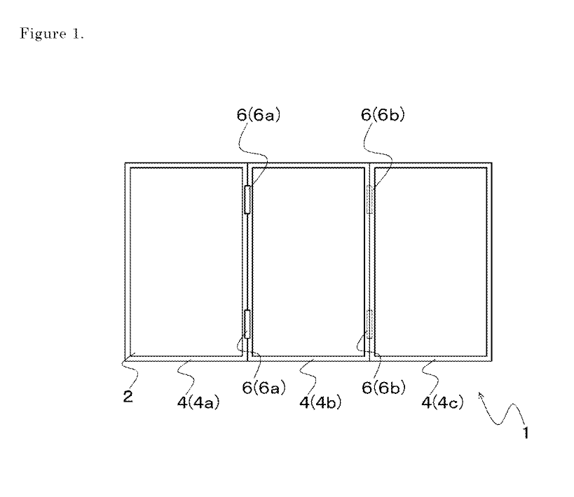

FIG. 1 is a front view of an image display device in accordance with an embodiment of the present invention in the exploded state into a substantially flat plane.

An image display device 1 is configured of three substantially plate-like housings (display unit, that is, unit display) 4 each having a display section 2: a first housing 4a , a second housing 4b, and a third housing 4c, the first housing 4a is connected to the second housing 4b via a first connecting portion 6a, and the second housing 4b is connected to the third housing 4c via a second connecting portion 6b (hereinafter, unless otherwise specified, the first to third housings are referred to as merely housing 4, and the first connecting portion 6a and the second connecting portion 6b are referred to as merely connecting portion 6). In this embodiment, a hinge as the connecting portion 6 connects the housings 4 to each other so that the housings 4 can rotate with respect to each other, the first connecting portion 6a is provided at an interface between the right side surface of the first housing 4a and the left side surface of the second housings 4, and the second connecting portion 6b is provided at an interface between the right side surface of the second housing 4b and the left side surface of the third housing 4c.

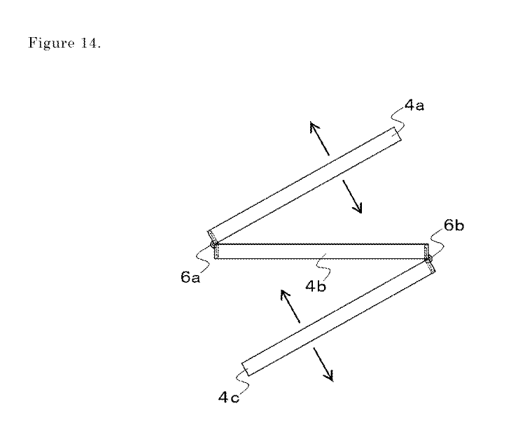

As shown in FIG. 14, the connecting portion 6 may be attached to a recess formed in the side surface of the housing 4.

For example, each of the housing 4 has the same size and shape as a general smart phone. The display section 2 of housing 4 may have or may not have flexibility, and the conventional general-purpose liquid crystal display as unchanged can be used as the display section. The housings 4 can be individually operated. For example, one housing 4 may be used as a general smart phone or a camera, and the remaining housings 4 may be used as displays.

By disposing the plurality of housings 4 in the substantially planar fashion, the plurality of display section 2 can collectively (integrally) form the almost same plane, functioning as a large one planar display section. Thus, even when each display section 2 is small, a large screen formed by integrating the display sections 2 can display information thereon.

The connecting portion 6 may be built in the large one planar display section, or may protrude from the surface of the large one planar display section. The connecting portion 6 may be a screw (or spring) and/or a magnet that connects the adjacent housings 4 to each other. In the case of the magnet, the housings 4 can be separated from each other.

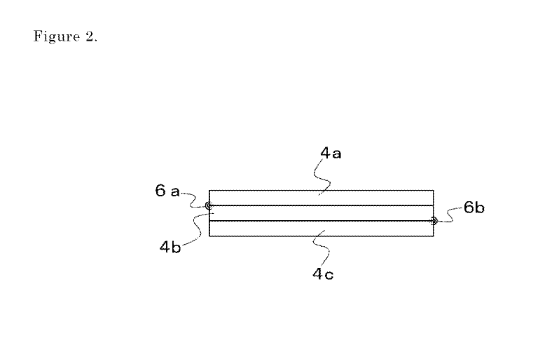

FIG. 2 is a plan view of the image display device in accordance with the embodiment of the present invention in the fully folded state. The image display device 1 can be made compact for storage by completely overlapping the housings 4, which is extremely advantageous for carrying. In this state, various types of information can be displayed on the foremost display section 2.

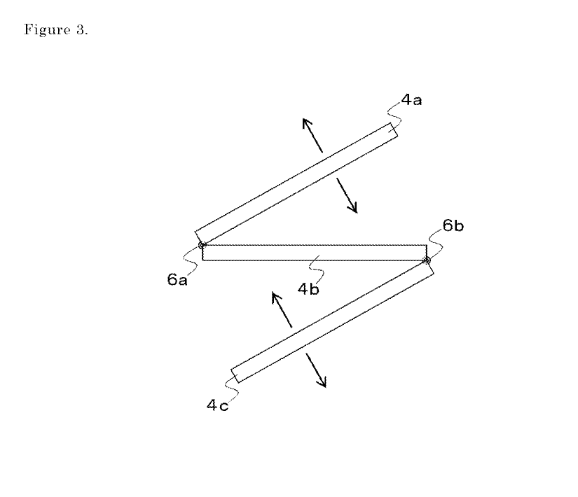

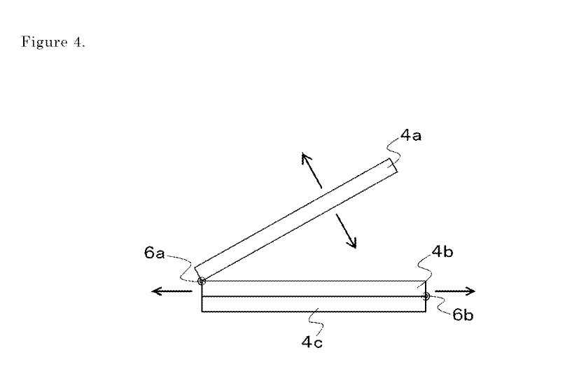

FIG. 3 and FIG. 4 are plan views of the image display device in accordance with the embodiment of the present invention in the folded states at some angles. By fixing at least one display section 2 at any angle or position such that the user can easily view the display section (for example, by means of frictional resistance of a hinge) as shown in FIG. 4, the image display device 1 can be suitably used on the table or the like. In the image display device according to the present invention, any display section 2 can be selected to display various types of information.

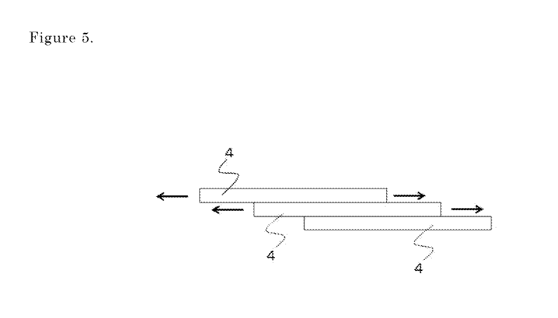

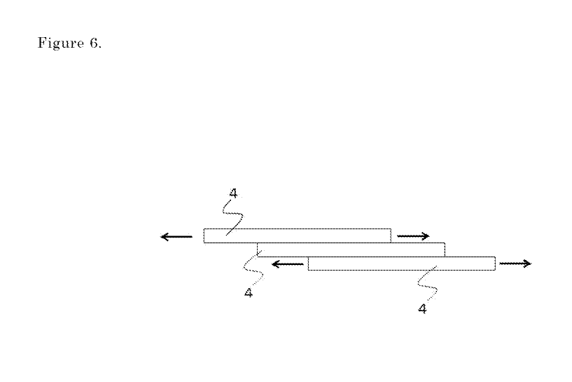

FIG. 5 and FIG. 6 are plan views of an image display device in accordance with another embodiment of the present invention in the slid state.

For example, although not shown, by providing a rail and a projection engaged with the rail in the upper surface and the lower surface of each housing 4, respectively, the housing 4 can be slid with respect to the adjacent housing 4 in the width direction. The housing 4 can be lifted so as to overlap the front surface (the surface having the display section) of the adjacent housing 4 and then, slid.

Alternatively, the housing 4 can be pushed downward so as to overlap the back surface (the surface having no display section) of the adjacent housing 4 and then, slid. Arrows in FIG. 3 to FIG. 6 represent examples of the direction in which the housings 4 can be rotated and/or slid.

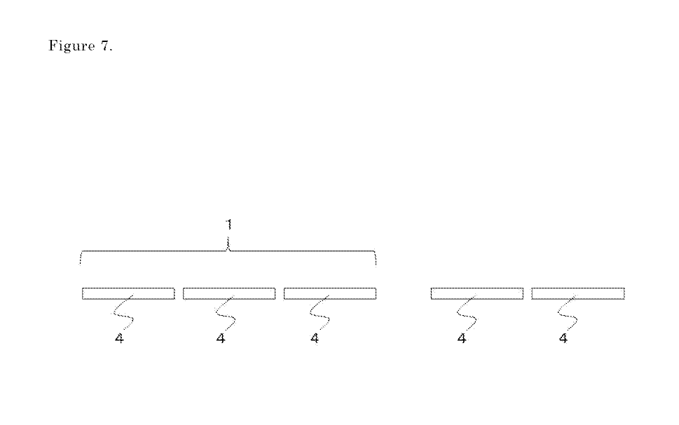

FIG. 7 is a plan view of an image display device in accordance with another embodiment of the present invention. In this embodiment, the image display device 1 is basically configured of the three housings 4 as described above, and may be connected to another housing 4.

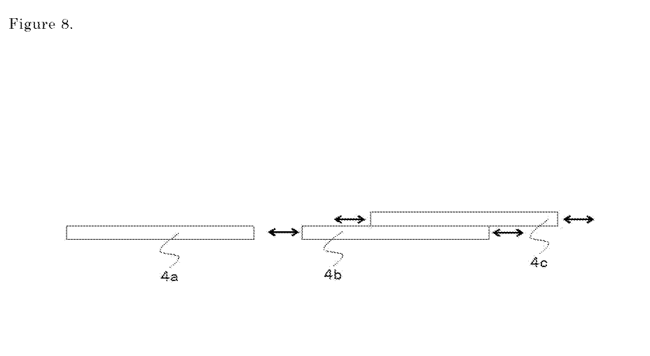

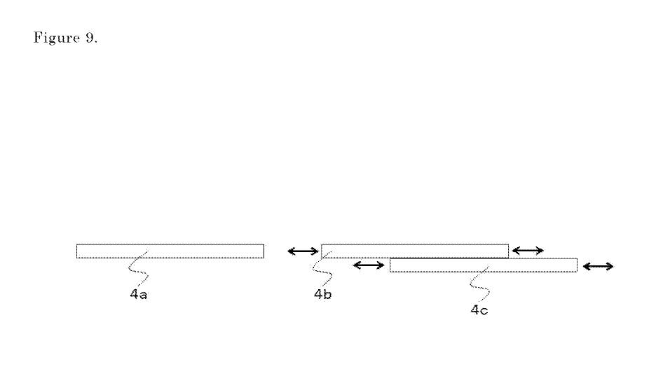

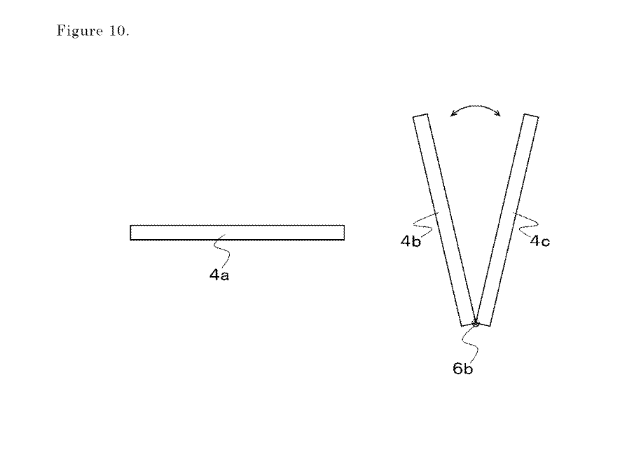

FIG. 8 and FIG. 9 are plan views of an image display device in accordance with still another embodiment of the present invention. The first housing 4a can be separated from the combination of the second housing 4b and the third housing 4c. The second housing 4b and the third housing 4c can be slid with respect to each other. Further, as shown in FIG. 10, the second housing 4b and the third housing 4c can be also rotated with respect to each other (Alternatively, the second housing 4b and the third housing 4c cannot be slid with respect to each other, but can be rotated with respect to each other).

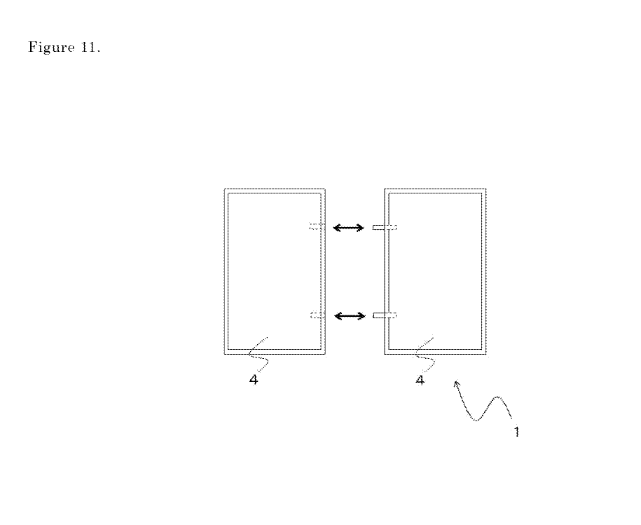

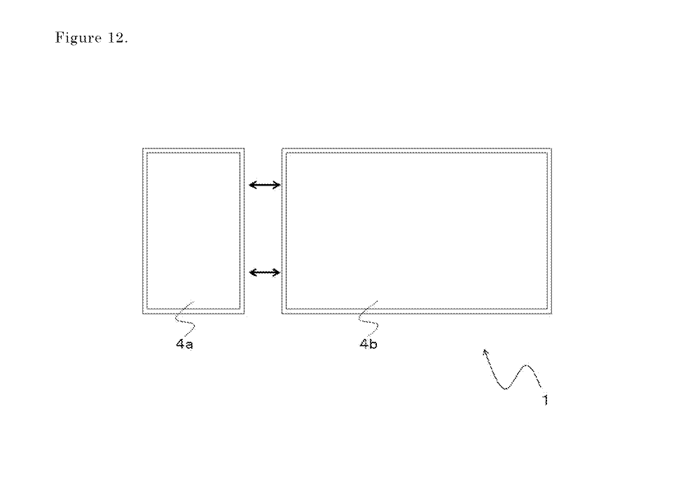

As shown in FIG. 11, the image display device 1 of the present invention may be configured such that the adjacent housings 4 can be connected to each other in the plug-in fashion, for example, via an USB terminal. As shown in FIG. 12, the first housing 4a and the second housing 4b that have different sizes may constitute the image display device 1.

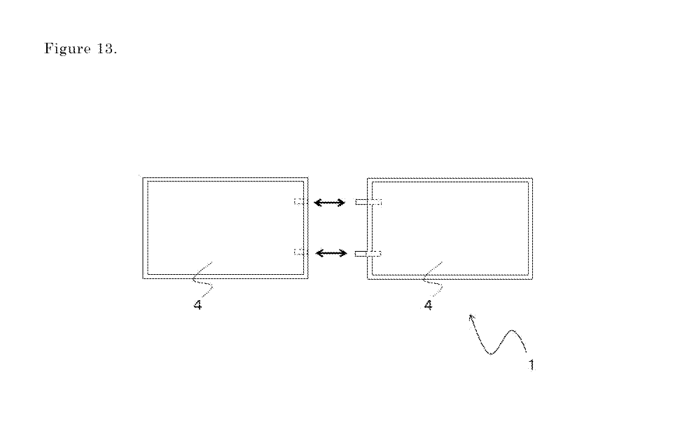

As shown in FIG. 13, the image display device 1 of the present invention may be configured such that the two rectangular housings 4 are connected to each other in the longitudinal direction, and may be used as a keyboard or the like. In this case, the combination of the two housings 4 as shown in the right part in FIG. 10 may be used as a display. In this case, it is possible to use the other rectangular housing as a mobile phone.

While the typical embodiments of the present invention have been described, the present invention are not limited to these, and various design changes may be made. While the three housings 4 are provided in some of the embodiments (FIG. 1 to FIG. 10 and FIG. 14), only the two housings may be provided as shown in FIG. 11 to FIG. 13, and four or more housings, though not illustrated, may be provided.

### REFERENCE SIGN LIST

1 Image display device
2 Display section
4 Housing
4a First housing
4b Second housing
4c Third housing
6 Connecting portion
6a First connecting portion
6b Second connecting portion

1. An image display device comprising:
a substantially plate-like first housing (display unit) having a first display section; and
a substantially plate-like second housing (display unit) having a second display section, wherein
the first housing and the second housing are connected to each other via a connecting portion so as to be rotatable and/or slidable with respect to each other,
the first housing and the second housing are adjustable at any relative angle or position, and
the first display section and the second display section can be substantially flush with each other.

2. The image display device according to claim 1, wherein
various types of information is displayed on any of the first display section and the second display section.

3. The image display device according to claim 1, wherein
various types of information is displayed on one integrated display means constituted of the first display section and the second display section.
